(19) United States
(12) Patent Application Publication
(10) Pub. No.: US 2011/0166927 A1
(43) Pub. Date: Jul. 7, 2011

(54) Dynamic Pricing Model For Online Advertising

(75) Inventors: Chaitanya Bandi, Cambridge, MA (US); Dinesh Garg, Beawar (IN); Krishna Pal Singh Rathore, Ajmer (IN); Sachin Garg, Bangalore (IN); Krishna Prasad Chitrapura, Bangalore (IN); Sourangshu Bhattacharya, Distt: 24 Parganas (North) (IN)

(73) Assignee: Yahoo! Inc., Sunnyvale, CA (US)

(21) Appl. No.: 12/683,658

(22) Filed: Jan. 7, 2010

(51) Int. Cl. G06Q 30/00

(52) U.S. Cl. 705/14.45

(57) ABSTRACT

The present invention provides methods and systems for use in association with an online advertising auction. Advertiser bid information may be obtained, including a maximum amount per impression and a target click through rate (“CTR”). Following serving, if a delivered CTR is equal to or greater than the target CTR, then pricing per impression is at the maximum amount. If, however, the delivered CTR is less than the target CTR, then pricing per impression is at an amount equal to the maximum amount per impression multiplied by the ratio of the delivered CTR to the target CTR.

### BACKGROUND

Online advertising continues to grow in scale and importance. Two common pricing models used, for instance, in display advertising, include impression-based pricing, such as CPM (cost per million impressions) and click-based pricing, such as CPC (cost per click). Each, however, has its drawbacks and limitations. For instance, in CPC models, the advertiser may be subject to risk from click fraud. With CPM models, for instance, the advertiser assumes the risk of paying for impressions without getting a satisfactory number of clicks. Furthermore, in some cases, CPC models may allow the advertiser to determine value and bidding based on just clicks, and CPM models may allow the advertiser to determine value and bidding based on just impressions. In reality, an advertiser may place varying degrees of importance on each, and ranges of each, etc. Ideally, a pricing model would allow advertisers a high degree of flexibility and options with respect to risk allocation, balancing and management, as well as with respect to balancing and allocation with regard to value associated with clicks or click through rate, impressions, and ranges of each.

There is a need for better bidding and pricing models for use in online advertising.

### SUMMARY

Some embodiments of the invention provide pricing models for use in online advertising. Serving mechanisms are also provided, which can be used with such pricing models.

Some embodiments of the invention provide methods and systems for use in association with an online advertising auction, which may be associated with an online advertising exchange. Methods and systems are provided that include pricing models that allow advertisers great flexibility with respect to balancing of risks and values associated with advertisement performance factors including impressions and clicks or click through rates.

Some embodiments of the invention include obtaining bid information relating to anticipated serving of a set of advertisement impressions. The bid information includes a maximum amount to be paid per impression as well as a target click through rate (“CTR”). After serving, information is obtained, including an actual (or measured or estimated actual) or delivered CTR associated with the set of advertisement impressions. Pricing associated with the set of impressions may be determined in accordance with the following. If the delivered CTR is equal to or greater than the target CTR, then pricing of each of the set of impressions is at the maximum amount. If, however, the actual click through rate is less than the target click through rate, then pricing of each of the set of impressions is at an amount equal to the maximum amount per impression multiplied by the ratio of the actual click through rate to the target click through rate.

Some embodiments of the invention provide a pricing model that can be viewed as a “hybrid” between CPM and CPC pricing models. Some embodiments effectively allow advertisers to structure a more flexible bid than is possible in CPM and CPC models, balancing between CPM and CPC aspects, including taking into account and optimizing their particular impression and click valuations, as well as risk balancing.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a graph illustrating pricing according to one embodiment of the invention; and

FIG. 5 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

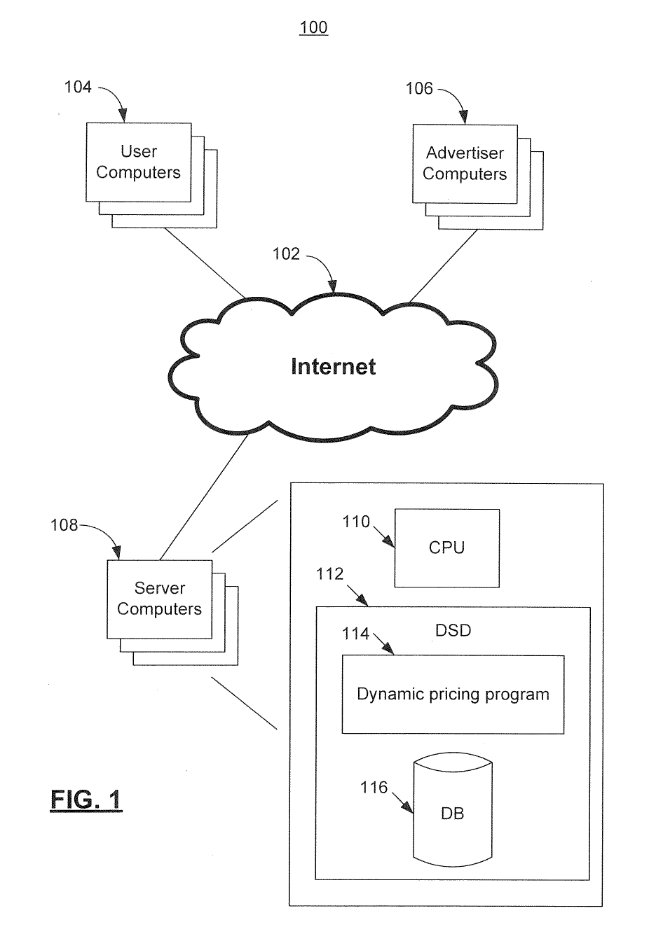

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Dynamic Pricing Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

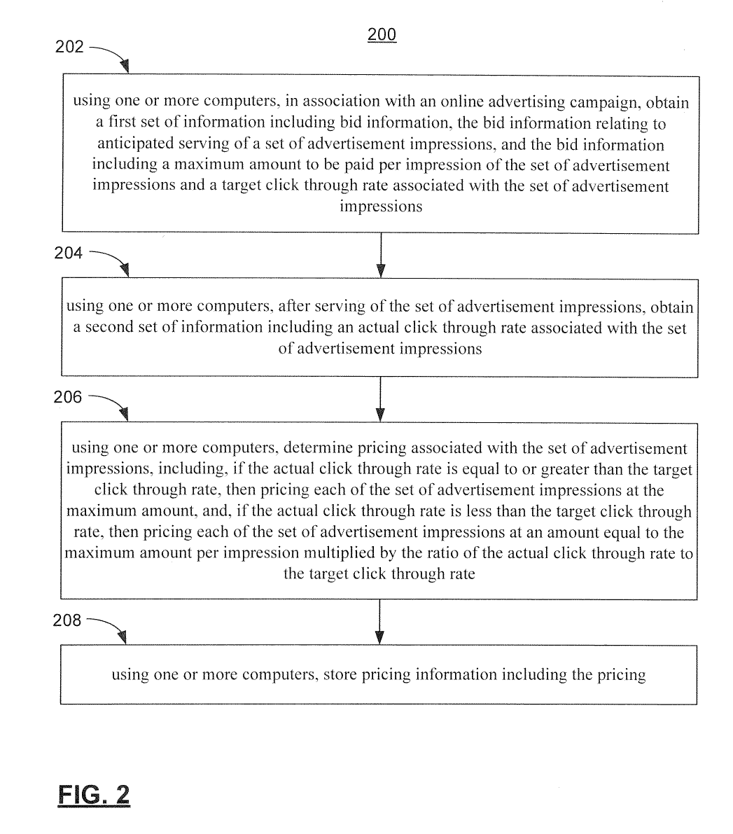

FIG. 2 is a flow diagram illustrating a method 200 according to one embodiment of the invention. At step 202, using one or more computers, in association with an online advertising campaign, a first set of information is obtained, including bid information. The bid information relates to anticipated serving of a set of advertisement impressions. The bid information includes a maximum amount to be paid per impression of the set of advertisement impressions and a target click through rate associated with the set of impressions.

At step 204, using one or more computers, after serving of the set of advertisement impressions, a second set of information is obtained, including an actual click through rate associated with the set of advertisement impressions.

At step 206, using one or more computers, pricing is determined, associated with the set of advertisement impressions. If the actual click through rate is equal to or greater than the target click through rate, then each of the set of advertisement impressions is priced at the maximum amount. If, however, the actual click through rate is less than the target click through rate, then each of the set of advertisement impressions is priced at an amount equal to the maximum amount per impression multiplied by the ratio of the actual click through rate to the target click through rate.

At step 208, using one or more computers, pricing information is stored, including the pricing.

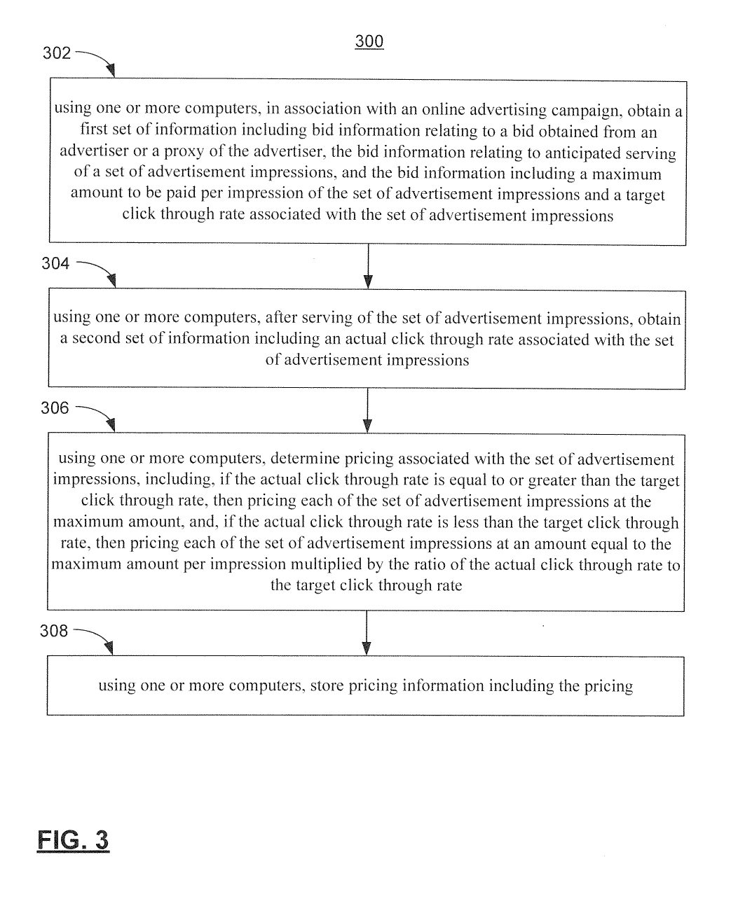

FIG. 3 is a flow diagram illustrating a method 300 according to one embodiment of the invention. At step 302, using one or more computers, in association with an online advertising campaign, a first set of information is obtained, including bid information relating to a bid obtained from an advertiser or a proxy of the advertiser. The bid information relates to anticipated serving of a set of advertisement impressions. The bid information includes a maximum amount to be paid per impression of the set of advertisement impressions and a target click through rate associated with the set of advertisement impressions.

Steps 304, 306 and 308 are similar to steps 202, 206 and 208 as depicted in FIG. 2.

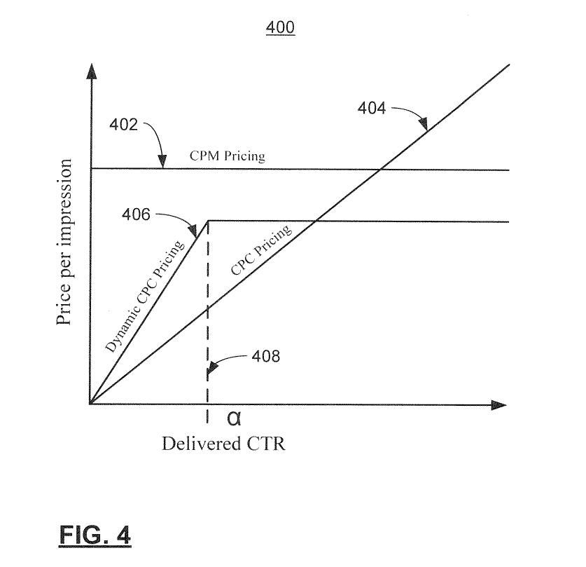

FIG. 4 is a graph 400 illustrating pricing according to one embodiment of the invention. Specifically, the graph 400 illustrates actual CTR, or delivered CTR, on the horizontal axis, versus price per impression on the vertical axis.

Particularly, the graph 400 illustrates curves associated with three different pricing models, including a CPM pricing model curve 402, a CPC pricing model curve 404, and a dynamic CPC pricing model curve 406 according to one embodiment of the invention.

According to a CPM pricing model, click through rate is irrelevant, and pricing is on a per impression basis. As such, the CPM pricing model curve 402 is horizontal, indicating the price per impression does not change with different delivered CTRs.

According to a CPC pricing model, number of impressions is irrelevant, and only the number of clicks, or click throughs, affects pricing. As such, the CPC pricing model curve 404 is a diagonal line, indicating that price per impression varies linearly with the delivered CTR. As a simplified example, if delivered CTR is 25%, and 100 impressions are delivered, and if cost per click is $1, then that works out to 25 clicks, so the price works out to $25, and the price per impression works out to $25/100=25 cents. If, however, delivered CTR is 50%, then that works out to 50 clicks, and the price works out to $50, so the price per impression works out to 50/100=50 cents.

The dynamic CPC pricing model curve 406, according to some embodiments, differs from both the CPM and CPC pricing model curves 402, 404. As depicted, α, depicted as element 408, represents the target CTR. Under a dynamic CPC pricing model, if delivered CTR is less than α, price per impression is given by the ratio of the delivered CTR to the target CTR multiplied by the maximum price. As such, the portion of the dynamic CPC pricing model curve 406 for α less than the target CTR resembles that of a pure CPC pricing model. However, for α greater than the target CTR, the dynamic CPC pricing model curve 406 resembles that of a pure CPM model.

It can be understood from the graph 400 that if α is set to 0 (or 0% CTR), then the entire dynamic CPC pricing model curve becomes a horizontal line. As such, setting α to zero effectively leads to a pure CPM pricing model curve. However, if α is set to 1 (or 100% CTR), then the entire dynamic CPC pricing model curve becomes a diagonal line, effectively leading to a pure CPC pricing model curve.

As such, in some embodiments, for any a other than 0 or 1, the dynamic CPC pricing model can be viewed as a hybrid or balance between CPM and CPC pricing models. This allows advertisers, in a sense, another “knob”, or “dial”, in their bidding, relative to CPM and CPC pricing models. With dynamic CPC pricing, the advertisers have a dial corresponding to maximum price per impression, and also a dial corresponding to target CTR. This allows advertisers much more flexibility and options in their bidding, allowing advertisers to much better optimize their bidding. Advertisers can structure their bidding with a balance of CPM and CTR considerations, depending on their unique business needs and valuations. It also allows advertisers to consider the different risks associated with CPC and CPM pricing models, and balance their dynamic CPC bidding with this in mind.

Notably, an entity that may facilitate or operate the auction may continue to choose how to decide how winning bids are selected, and appropriate serving schemes. This allows that entity to optimize from its perspective as well.

As such, some embodiments of the invention lead to a much better optimized and balanced auction or marketplace “ecosystem”, both from the advertiser and auction facilitator entity perspectives. Furthermore, a better optimized auction ecosystem leads to greater value for both the advertiser and the auction facilitator entity, which can in turn lead to increased participation, investment, and growth in the marketplace as a whole.

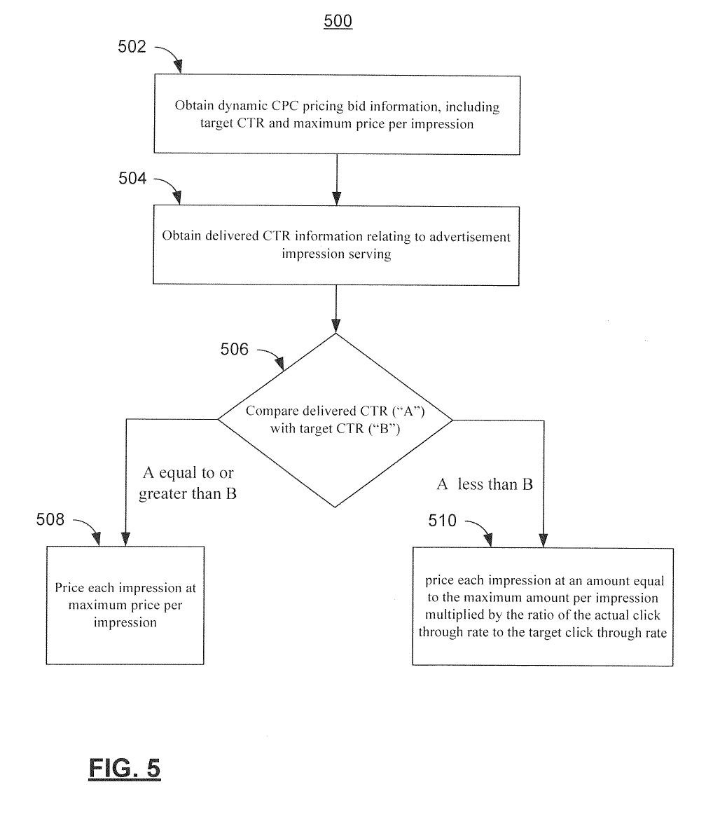

FIG. 5 is a flow diagram illustrating a method 500 according to one embodiment of the invention. At step 502, dynamic CPC pricing bid information is obtained, including a target CTR and a maximum price per impression. The bid information may relate, for example, to anticipated serving of a set of advertisement impressions according to a specified set of conditions, such as targeting conditions, etc., over a specified period of time.

At step 504, delivered CTR information is obtained relating to advertisement impression serving. This step can follow serving of the set of impressions.

At step 506, the method 500 compares the delivered CTR associated with the set of impressions to the target CTR. If the delivered CTR is equal to or create than the target CTR, then, at step 508, the price per impression is at the maximum price per impression. If, however, the delivered CTR is less than the target CTR, then, at step 510, the price per impression is at an amount equal to the maximum amount per impression multiplied by the ratio of the actual click through rate to the target click through rate.

It is to be understood that the term “delivered” is intended to be associated with actual CTR, or measures thereof, and is not intended to imply that actual serving of impressions is necessarily a part of some embodiments of the invention.

Some embodiments of the invention provide serving schemes that can be utilized with dynamic CPC pricing models according to embodiments of the invention. The following is a description of two such schemes. One scheme (referred to hereinafter as the “unknown CTR, unbudgeted scheme”) is optimized relative to a hypothetical context in which forecasted CTR is unknown, and advertisers have no budgets, or maximum spends. The second scheme (referred to hereinafter as the “known CTR, budgeted scheme”) is optimized relative to a hypothetical context in which forecasted CTR is known, and in which advertisers have budgets. Embodiments of the invention also contemplate hybrids, blends, or related schemes.

In some embodiments, an unknown CTR, unbudgeted scheme is given as following algorithm (Algorithm 1):

Initialization: serve each advertisement once.

Loop: For every t^{th} request, serve an advertisement I that maximizes the index:

[min(bᵢ((bᵢ/αᵢ)(cᵢ(t−1)/nᵢ(t−1))))+(bᵢ/α)ᵢ)√((2 log(t−1))/(nᵢ(t−1)))] (Eq. 1)

In the above, i denotes a particular advertiser, bi denotes the maximum price per impression element of a dynamic CPC bid, and αi denotes the target CTR element of a dynamic CPC bid. Furthermore, nᵢ(t−1) denotes the number of times advertiser Aᵢ's advertisement has been served before serving the t^{th} request, and cᵢ(t−1) denotes the number of clicks fetched by Aᵢ's advertisement before serving the t^{th} request.

In some embodiments, the unknown CTR, unbudgeted scheme minimizes a quantity referred to herein as “regret”. In the following, it is hypothetically assumed that there are u advertisers. Furthermore, it is hypothetically assumed that an advertisement serving scheme S serves advertisements to an incoming advertisement serving request sequence having length n for a single web page. It is further assumed that each advertiser Aᵢ has submitted a dynamic CPC bid (bᵢ, αᵢ), including a maximum price per impression bᵢ and a target CTR αᵢ.

Regret (R) can be defined as follows:

R(S)=E[min(b*,(b*/α*)(c*/n))]n−Σ(over i=1 to u)E[min(bᵢ,(bᵢ/αᵢ)(cᵢ/nᵢ))]nᵢ (Eq. 2)

In Eq. 2, the first term represents the maximum possible expected reward in this context.

In some embodiments, a known CTR, budgeted scheme is given in following algorithm (Algorithm 2):

Define Kᵢⱼ=min(bᵢⱼ,(bᵢⱼ/αᵢⱼCTRᵢⱼ)∀_{i,j} (Eq. 3)

Invoke Algorithm A with bids bᵢⱼ=kᵢⱼ

In Algorithm 2, algorithm A can be a known algorithm for an online scheme such as, for example, that proposed in the following publication, which is hereby incorporated herein by reference in its entirety: A. Mehta, A. Saberi, and V. V. Vazirani. Adwords and generalized online matching. In 46th Annual IEEE Symposium on Foundations of Computer Science (FOCS'05), Pittsburgh, Pa., 2005.

It is further to be understood that embodiments of the invention can be used with many different forms of online advertising, including graphical advertising as well as sponsored search advertising.

Some embodiments of the invention are described with a conditional pricing model in which an actual or delivered CTR being equal to or greater than a target CTR leads to one outcome, and actual or delivered CTR being less than a target CTR leads to another outcome. It is to be understood, however, that the invention contemplates other embodiments with different conditionals, including, for example, embodiments in which an equal to condition leads to a different or opposite outcome, and embodiments in which an equal condition may not or cannot exactly occur.

While the invention is described with reference to the above drawings, the drawings are intended to be illustrative, and the invention contemplates other embodiments within the spirit of the invention.

1. A method for use in association with an online advertising auction, comprising:
using one or more computers, in association with an online advertising campaign, obtaining a first set of information comprising bid information, the bid information relating to anticipated serving of a set of advertisement impressions, and the bid information comprising:
a maximum amount to be paid per impression of the set of advertisement impressions; and
a target click through rate associated with the set of advertisement impressions;
using one or more computers, after serving of the set of advertisement impressions, obtaining a second set of information comprising an actual click through rate associated with the set of advertisement impressions;
using one or more computers, determining pricing associated with the set of advertisement impressions, comprising:
if the actual click through rate is equal to or greater than the target click through rate, then determining a price of each of the set of advertisement impressions at the maximum amount; and
if the actual click through rate is less than the target click through rate, then determining a price of each of the set of advertisement impressions at an amount equal to the maximum amount multiplied by a ratio of the actual click through rate to the target click through rate; and
using one or more computers, storing pricing information including the pricing.

2. The method of claim 1, comprising charging an entity associated with the advertising campaign in accordance with the pricing.

3. The method of claim 1, wherein the bid information relates to a bid associated with an advertiser or a proxy of an advertiser, and comprising obtaining the bid from the advertiser or the proxy of the advertiser.

4. The method of claim 1, wherein the set of advertisement impressions comprises impressions won during the online advertising auction.

5. The method of claim 1, wherein the set of advertisement impressions comprises impressions served during a specified period of time.

6. The method of claim 1, wherein serving, of impressions comprising the set of advertisement impressions, is optimized with respect to revenue associated with an auction operation entity.

7. The method of claim 6, wherein serving of impressions comprising the set of advertisement impressions is optimized given assumptions that forecasted click through rate of anticipated impressions is unknown, and that there are no budgetary constraints associated with anticipated impressions.

8. The method of claim 7, wherein serving, of impressions comprising the set of advertisement impressions, is optimized with respect to minimizing regret.

9. The method of claim 6, wherein serving of impressions comprising the set of advertisement impressions is optimized given assumptions that forecasted click through rate of anticipated impressions is known, and that there are budgetary constraints associated with anticipated impressions.

10. The method of claim 1, The method of claim 1, comprising charging an entity associated with the advertising campaign in accordance with the pricing, and comprising storing information relating to the charging.

11. The method of claim 1, wherein the bid information relates to a bid associated with an advertiser or a proxy of the advertiser, and comprising obtaining the bid from the advertiser or the proxy of the advertiser, and wherein the bid specifies only an amount that the advertiser or the proxy of the advertiser agrees to pay on condition that a specified minimum number of clicks are obtained per a specified amount of spend.

12. The method of claim 11, wherein an agreement between the advertiser, or the proxy of the advertiser, and an auction operation entity specifies that the advertiser, or the proxy of the advertiser, will be charged some amount less than the amount if the number of clicks obtained per the specified amount of spend is below the minimum number.

13. The method of claim 1, comprising serving of impressions including the set of advertisement impressions.

14. The method of claim 1, wherein the set of advertisement impressions is a set of impressions served during a specified period of time.

15. The method of claim 1, wherein the set of advertisement impressions is a set of impressions meeting certain specified conditions for serving and served during a specified period of time.

16. A system comprising:
one or more server computers connected to a network; and
one or more databases connected to the one or more servers;
wherein the one or more server computers are for:
in association with an online advertising campaign, obtaining a first set of information comprising bid information, the bid information relating to anticipated serving of a set of advertisement impressions, and the bid information comprising:
a maximum amount to be paid per impression of the set of advertisement impressions; and
a target click through rate associated with the set of advertisement impressions;
after serving of the set of advertisement impressions, obtaining a second set of information comprising an actual click through rate associated with the set of advertisement impressions;
determining pricing associated with the set of advertisement impressions, comprising:
if the actual click through rate is equal to or greater than the target click through rate, then determining a price of each of the set of advertisement impressions at the maximum amount; and
if the actual click through rate is less than the target click through rate, then determining a price of each of the set of advertisement impressions at an amount equal to the maximum amount multiplied by a ratio of the actual click through rate to the target click through rate; and
storing pricing information including the pricing.

17. The system of claim 16, wherein the online advertising auction is associated with an online advertising exchange.

18. The system of claim 16, comprising facilitating serving of impressions including the set of advertisement impressions.

19. The system of claim 16, wherein the network comprises the Internet.

20. A computer readable medium or media containing instructions for executing a method for use in association with an online advertising auction, comprising, the method comprising:
using one or more computers, in association with an online advertising campaign, obtaining a first set of information comprising bid information, the bid information relating to anticipated serving of a set of advertisement impressions, and the bid information comprising:
a maximum amount to be paid per impression of the set of advertisement impressions; and
a target click through rate associated with the set of advertisement impressions;
using one or more computers, after serving of the set of advertisement impressions, obtaining a second set of information comprising an actual click through rate associated with the set of advertisement impressions;
using one or more computers, determining pricing associated with the set of advertisement impressions, comprising:
if the actual click through rate is equal to or greater than the target click through rate, then determining a price of each of the set of advertisement impressions at the maximum amount; and
if the actual click through rate is less than the target click through rate, then determining a price of each of the set of advertisement impressions at an amount equal to the maximum amount multiplied by a ratio of the actual click through rate to the target click through rate; and
using one or more computers, storing pricing information including the pricing.
